(19) United States
(12) Patent Application Publication
(10) Pub. No.: US 2021/0017443 A1
(43) Pub. Date: Jan. 21, 2021

(54) METHODS OF USING TREATMENT FLUIDS INCLUDING WEAKLY EMULSIFYING SURFACTANTS

(71) Applicant: Multi-Chem Group, LLC, Houston, TX (US)

(72) Inventors: Liang X. Xu, The Woodlands, TX (US); James W. Ogle, Livingston, TX (US); Christopher Gentilini, Dickinson, ND (US); Jake Dworshak, Dickinson, ND (US)

(21) Appl. No.: 16/517,247

(22) Filed: Jul. 19, 2019

(51) Int. Cl. C09K 8/584

(52) U.S. Cl. CPC C09K 8/584

(57) ABSTRACT

Methods for treating a subterranean formation using treatment fluids including a weakly emulsifying surfactant are provided. In one or more embodiments, the methods include introducing a first treatment fluid comprising a base fluid and a weakly emulsifying surfactant into a first wellbore penetrating at least a first portion of a subterranean formation; and introducing a second treatment fluid into a second wellbore penetrating at least a second portion of the subterranean formation at a pressure sufficient to create or enhance one or more fractures extending from the second wellbore into the subterranean formation.

### BACKGROUND

The present disclosure relates to methods for treating a subterranean formation using treatment fluids including weakly emulsifying surfactants.

Treatment fluids may be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid. Illustrative treatment operations may include, for example, fracturing operations, shut-in operations, gravel packing operations, acidizing operations, scale dissolution and removal, consolidation operations, and the like. For example, a fluid may be used to drill a wellbore in a subterranean formation or to complete a wellbore in a subterranean formation, as well as numerous other purposes.

One common production stimulation operation that employs a treatment fluid is hydraulic fracturing. Hydraulic fracturing operations generally involve pumping a treatment fluid (e.g., a fracturing fluid) into a wellbore that penetrates a subterranean formation at a sufficient hydraulic pressure to create or enhance one or more cracks, or “fractures,” in the subterranean formation. The fracturing fluid may include particulates, often referred to as “proppant particulates,” that are deposited in the fractures. The proppant particulates function, inter alfa, to prevent the fractures from fully closing upon the release of hydraulic pressure, forming conductive channels through which fluids may flow to the wellbore. When a second wellbore that is located proximate to another wellbore is fractured, the fractures from the second wellbore may come into fluid communication with the first wellbore or fractures extending therefrom, and proppant particulates introduced into the second wellbore may enter the first wellbore or fractures extending therefrom, requiring that the first wellbore be cleaned out before hydrocarbon production can begin.

### BRIEF DESCRIPTION OF THE DRAWINGS

These drawings illustrate certain aspects of some of the embodiments of the present disclosure and should not be used to limit or define the claims.

FIGURE 1 is a cross-sectional view of a subterranean formation with a first wellbore and a second wellbore disposed therein according to certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to methods for treating subterranean formations. More particularly, the present disclosure relates to methods for treating subterranean formations using treatment fluids including weakly emulsifying surfactants.

The present disclosure provides methods that include introducing a first treatment fluid that includes a base fluid and a weakly emulsifying surfactant into a first wellbore penetrating at least a portion of a subterranean formation. The present disclosure also provides methods that include introducing a second treatment fluid into a second wellbore penetrating at least a portion of the subterranean formation at a pressure sufficient to create or enhance one or more fractures extending from the second wellbore into the subterranean formation. In certain embodiments, at least a portion of the second wellbore (including fractures extending therefrom) is located proximate to at least a portion of the first wellbore (including fractures extending therefrom).

Among the many potential advantages to the methods of the present disclosure, only some of which are alluded to herein, the methods may at least partially prevent a first wellbore and/or fractures extending therefrom from hydraulically or fluidly communicating with a nearby second wellbore that is fractured. In certain embodiments, the methods of the present disclosure may at least partially prevent a fracturing fluid, or components thereof (e.g., particulates), that is used to fracture the nearby second wellbore from entering the first wellbore and/or one or more fractures extending thereof. In certain embodiments, the method of the present disclosure may allow the first wellbore to be returned to normal hydrocarbon production after the nearby second wellbore has been fractured without the need to clean out or otherwise remove particulates used to fracture the nearby second wellbore from the first wellbore and without the need for artificial lift and/or other stimulation treatments.

In one or more embodiments, the methods of the present disclosure include introducing a first treatment fluid including a base fluid and a weakly emulsifying surfactant into a first wellbore penetrating at least a portion of a subterranean formation. In certain embodiments, the first treatment fluid may further include a biocide, a clay stabilizer, a scale inhibitor, an oxygen scavenger, and/or a corrosion inhibitor. In one or more embodiments, the methods of the present disclosure include introducing a second treatment fluid into a second wellbore penetrating at least a portion of the subterranean formation. In certain embodiments, the second treatment fluid may include a base fluid and a plurality of particulates.

The treatment fluids that may be useful in accordance with the present disclosure may comprise any base fluid known in the art, including aqueous base fluids, non-aqueous base fluids, and any combinations thereof. The term “base fluid” refers to the major component of the fluid (as opposed to components dissolved and/or suspended therein) and does not indicate any particular condition or property of that fluids such as its mass, amount, pH, etc.

In certain embodiments, the treatment fluids of the present disclosure include an aqueous base fluid. Aqueous base fluids that may be suitable for use in the methods of the present disclosure may include water from any source. Such aqueous base fluids may include fresh water, salt water (e.g., water containing one or more salts dissolved therein), brine (e.g., saturated salt water), seawater, produced water, or any combination thereof. For example, seawater and/or produced water may include a variety of divalent or trivalent cationic species dissolved therein. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. One of ordinary skill in the art with the benefit of this disclosure will recognize when such density and/or pH adjustments are appropriate.

In certain embodiments, the treatment fluids of the present disclosure include a non-aqueous base fluid. Examples of non-aqueous base fluids that may be suitable for use in the methods and systems of the present disclosure include, but are not limited to oils, hydrocarbons, organic liquids, gases (e.g., natural gas, produce gas, carbon dioxide, nitrogen), supercritical gases, liquified natural gas, and the like.

The treatment fluids used in the methods of the present disclosure may include a weakly emulsifying surfactant. Weakly emulsifying surfactants suitable for use in some embodiments of the present disclosure include any surfactant capable of forming relatively short-lived, or transient, oil-in-acid, oil-in-water, or other oil-in-aqueous phase emulsions. In some embodiments, suitable weakly emulsifying surfactants may be characterized by their capability to form oil-in-acid or oil-in-water emulsions that break and reform whenever the emulsion is subjected to shear forces. Thus, in some embodiments, use of a treatment fluid including the weakly emulsifying surfactant in a formation may result in emulsions that break apart and reform when subjected to shear flow in the formation. The weakly emulsifying surfactant may in some embodiments be cationic, while in other embodiments it may be anionic, or in yet other embodiments, amphoteric, zwitterionic, or non-ionic, respectively.

Examples of suitable weakly emulsifying surfactants include, but are not limited to, ethoxylated amines, ethoxylated long-chain alcohols, polyglucosides, alkyl ammonium bromides, alkyl sulfonates, alkoxylated sulfates, hydroxysultaines, and any combinations thereof. Suitable non-ionic weakly emulsifying surfactants of some embodiments may include, but are not limited to: ethoxylated alcohols and polyglucosides. In some embodiments, non-ionic weakly emulsifying surfactants may include ethoxylated long-chain alcohols (e.g., ethoxylated dodecanol). Ethoxylation may take place at any point along the alcohol. Suitable cationic weakly emulsifying surfactants of some embodiments may include, but are not limited to: alkyl ammonium bromides. In some embodiments, the alkyl chain of the alkyl ammonium bromide may be anywhere from 1 to 50 carbons long, and be branched or un-branched. Thus, an example embodiment may include an alkyl ammonium bromide that comprises a 16-carbon chain alkyl component (e.g., cetyl trimethyl ammonium bromide). Suitable anionic weakly emulsifying surfactants of some embodiments may include, but are not limited to: alkyl sulfonates (e.g., methyl sulfonate, heptyl sulfonate, decylbenzene sulfonate, dodecylbenzene sulfonate, etc.) and alkoxylated sulfates. Suitable amphoteric and/or zwitterionic weakly emulsifying surfactants of some embodiments may include, but are not limited to, hydroxysultaines (e.g., cocoamidopropyl hydroxysultaine, lauramidopropyl hydroxysultaine, lauryl hydroxysultaine, etc.).

In certain embodiments, the weakly emulsifying surfactant may be present in the treatment fluid in an amount up to about 2.0% volume by volume of the treatment fluid. In other embodiments, the weakly emulsifying surfactant may be present in the treatment fluid in an amount from about 0.01% to about 2.0% volume by volume of the treatment fluid. In other embodiments, the weakly emulsifying surfactant may be present in the treatment fluid in an amount from about 0.2% to about 1.5% volume by volume of the treatment fluid. In other embodiments, the weakly emulsifying surfactant may be present in the treatment fluid in an amount from about 0.5% to about 1.0% volume by volume of the treatment fluid.

The treatment fluids used in the methods of the present disclosure may include one or more particulates. Examples of suitable particulates include, but are not limited to, fly ash, silica, alumina, fumed carbon (e.g., pyrogenic carbon), carbon black, graphite, mica, titanium dioxide, metal-silicate, silicate, kaolin, talc, zirconia, boron, hollow microspheres (e.g., spherical shell-type materials having an interior cavity), glass, sand, bauxite, sintered bauxite, ceramic, calcined clays (e.g., clays that have been heated to drive out volatile materials), partially calcined clays (e.g., clays that have been heated to partially drive out volatile materials), composite polymers (e.g., thermoset nanocomposites), halloysite clay nanotubes, and any combination thereof. The particulates may be of any shape (regular or irregular) suitable or desired for a particular application (e.g., fracturing, gravel packing, bridging). In some embodiments, the particulates may be round or spherical in shape, although they may also take on other shapes such as ovals, capsules, rods, toroids, cylinders, cubes, or variations thereof. In certain embodiments, the particulates may be present in the treatment fluid in an amount from about 0.01 to about 10 pounds per gallon (“ppg”) of the treatment fluid. In other embodiments, the particulates may be present in the treatment fluid in an amount from about 0.1 to about 4 ppg of the treatment fluid. In other embodiments, the particulates may be present in the treatment fluid in an amount from about 0.5 to about 2.5 ppg of the treatment fluid.

In certain embodiments, the treatment fluids used in the methods of the present disclosure optionally may include any number of additives. Examples of such additives include, but are not limited to, gel stabilizers, salts, fluid loss control additives, scale inhibitors, corrosion inhibitors, catalysts, clay stabilizers, oxygen scavengers, biocides, bactericides, friction reducers, liquefied gases, produced gases, CO₂, foaming agents, iron control agents, solubilizers, pH adjusting agents (e.g., buffers), and the like. One of ordinary skill in the art with the benefit of this disclosure will recognize the types of additives that may be included in the treatment fluids of the present disclosure for a particular application.

In certain embodiments, the treatment fluids used in the methods of the present disclosure may include a clay stabilizer. In certain embodiments, the clay stabilizer may stabilize the subterranean formation into which the treatment fluid is being introduced (e.g., wellbore and fractures extending thereof) so that the subterranean formation may withstand and/or contain the treatment fluid being introduced into the wellbore. Examples of suitable clay stabilizers include, but are not limited to, salts of inorganic and organic acids (e.g., sodium chloride, potassium chloride, ammonium chloride), polyamines, cationic polymers and oligomers (e.g., poly(dimethyldiallylammonium chloride)), anionic, cationic, amphoteric, nonionic poly(acrylamide) and its copolymers, cationic poly(diemethylaminoethylmethacrylate), anionic polyacrylic acid and any combinations thereof. In certain embodiments, the clay stabilizer may be present in the treatment fluid in an amount from about 0.01 to about 10 gallons per thousand gallons (“gpt”) of the treatment fluid. In other embodiments, the clay stabilizer may be present in the treatment fluid in an amount from about 0.1 to about 5 gpt of the treatment fluid. In other embodiments, the clay stabilizer may be present in the treatment fluid in an amount from about 0.2 to about 1.0 gpt of the treatment fluid.

In certain embodiments, the treatment fluids used in the methods of the present disclosure may include a biocide. Examples of suitable biocides include, but are not limited to, hypochlorite bleach, cyanuric acids (e.g., trichloroisocyanuric acid), halogenated salts (e.g., lithium hypochlorite, peroxide-based compounds), and the like, and any combination thereof. In certain embodiments, the biocide may be present in the treatment fluid in an amount from about 0.01 to about 10 gpt of the treatment fluid. In other embodiments, the biocide may be present in the treatment fluid in an amount from about 0.1 to about 0.3 gpt of the treatment fluid.

In certain embodiments, the treatment fluids used in the methods of the present disclosure may include a scale inhibitor. Examples of suitable scale inhibitors include, but are not limited to, polyphosphates, phosphate esters, phosphonates, polyacrylic acid and salts thereof, other carboxylic acid containing polymers, and any combinations thereof. In certain embodiments, the scale inhibitor may be present in the treatment fluid in an amount from about 0.01 to about 20 gpt of the treatment fluid. In other embodiments, the scale inhibitor may be present in the treatment fluid in an amount from about 0.1 to about 0.5 gpt of the treatment fluid.

In certain embodiments, the treatment fluids used in the methods of the present disclosure may include an oxygen scavenger. Examples of suitable oxygen scavengers include, but are not limited to, stannous chloride, sulfite, tannin, carbohydrazide, sulfites, hydrazine, erythorbates, and combinations thereof. In certain embodiments, the oxygen scavenger may be present in the treatment fluid in an amount from about 0.001 to about 10 gpt of the treatment fluid.

In certain embodiments, the treatment fluids used in the methods of the present disclosure may include a corrosion inhibitor. Examples of suitable corrosion inhibitors include, but are not limited to, acetylenic alcohols, Mannich condensation products (such as those formed by reacting an aldehyde, a carbonyl containing compound and a nitrogen containing compound), unsaturated carbonyl compounds, unsaturated ether compounds, formamide, formic acid, formates, other sources of carbonyl, iodides, terpenes, and aromatic hydrocarbons, coffee, tobacco, gelatin, cinnamaldehyde, cinnamaldehyde derivatives, acetylenic alcohols, fluorinated surfactants, quaternary derivatives of heterocyclic nitrogen bases, quaternary derivatives of halomethylated aromatic compounds, formamides, combinations of such compounds used in conjunction with iodine; quaternary ammonium compounds, and any combinations thereof. In certain embodiments, the corrosion inhibitor may be present in the treatment fluid in an amount from about 0.01 to about 10 gpt of the treatment fluid.

In one or more embodiments, the additives used in the treatment fluids used in the present disclosure (e.g., weakly emulsifying surfactant, clay stabilizer, biocide, scale inhibitor, oxygen scavenger, corrosion inhibitors) may be added to the base fluid along with any other additives at a well site where the operation or treatment is conducted, either by batch mixing or continuous (“on-the-fly”) mixing. The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing. In one or more embodiments, the additives used in the treatment fluids used in the present disclosure (e.g., weakly emulsifying surfactant, clay stabilizer, biocide, scale inhibitor, oxygen scavenger, corrosion inhibitors) may be batched into one or more tanks of the base fluid before being introduced into the wellbore. In some embodiments, the treatment fluids of the present disclosure may be prepared, either in whole or in part, at an offsite location and transported to the site where the treatment or operation is conducted. In introducing a treatment fluid into a wellbore and/or a portion of a subterranean formation, the components of the treatment fluid may be mixed together at the surface and introduced into the wellbore and/or formation together, or one or more components may be introduced into the wellbore and/or formation at the surface separately from other components such that the components mix or intermingle in the wellbore and/or a portion of the formation to form a treatment fluid. In either such case, the treatment fluid is deemed to be introduced into at least a wellbore and/or a portion of the subterranean formation for purposes of the present disclosure.

In one or more embodiments, the first treatment fluid including a base fluid, a weakly emulsifying surfactant, and, optionally, other additives (e.g., clay stabilizer, biocide, scale inhibitor, oxygen scavenger, and corrosion inhibitor) may be introduced into a first wellbore penetrating at least a portion of a subterranean formation. In certain embodiments, the first treatment fluid may be introduced into the first wellbore using one or more pumps. In certain embodiments, the first wellbore may have one or more fractures extending therefrom. In some embodiments, the first treatment fluid may enter the one or more fractures. In certain embodiments, the introduction of the first treatment fluid into the first wellbore may pressurize the first wellbore and/or the one or more fractures extending therefrom.

In certain embodiments, the amount of the first treatment fluid added to the first wellbore may be from about 1,500 barrels (“bbl”) to about 100,000 bbl. One of ordinary skill in the art with the benefit of this disclosure will recognize that the volume of the first treatment fluid required to sufficiently pressurize the first wellbore may vary based on, among other things, the size of the wellbore and/or the amount and size of fractures extending therefrom.

In certain embodiments, an over flush fluid may be introduced into the first wellbore after the first treatment fluid. In one or more embodiments, the over flush fluid may include a base fluid and one or more additives (e.g., biocide, scale inhibitor, oxygen scavenger, and corrosion inhibitor), as described above. In certain embodiments, the volume of the over flush fluid introduced to the first wellbore may be up to 50% of the volume of the first treatment fluid. For example, if 2,000 bbl of the first treatment fluid are introduced into the first wellbore, then up to 1,000 bbl of the over flush fluid may be introduced into the first wellbore.

In one or more embodiments, after the first treatment fluid, and optionally the over flush fluid, has been introduced into the first wellbore, the first wellbore may be shut in at the surface for a period of time. The shut in may be a soft shut in or a hard shut in. In certain embodiments, the first wellbore may be shut in before the second treatment fluid is introduced into the second wellbore and may remained shut in a period of time thereafter, for example, while the second treatment fluid is being introduced. In certain embodiments, the first wellbore may be shut in for a period of time ranging from about few hours to about few weeks. In certain embodiments, the first wellbore may be shut in for at least about 14 days.

In one or more embodiments, a second treatment fluid may be introduced into a second wellbore located proximate to the first wellbore. Although referred to herein as “a first wellbore” and “a second wellbore,” one skilled in the art with the benefit of this disclosure will recognize that there may be multiple wellbores proximate to the first wellbore in which the methods of the present disclosure may be employed. In certain embodiments, the second treatment fluid may be introduced into the second wellbore or the subterranean formation at a pressure sufficient to create or enhance one or more fractures (e.g., primary fractures, cracks, microfractures, and/or microcracks) within the subterranean formation (e.g., hydraulic fracturing). In certain embodiments, at least a portion of the second wellbore (or a fracture extending therefrom) may be located proximate to at least a portion of the first wellbore (or a fracture extending therefrom). In certain embodiments, a wellhead of the first wellbore at the surface may be located from about 0.001 to about 10.0 miles from a wellhead of the second wellbore at the surface. In other embodiments, the wellhead of the first wellbore at the surface may be located from about 0.001 to about 5.0 miles from the wellhead of the second wellbore at the surface. In other embodiments, the wellhead of the first wellbore at the surface may be located from about 0.001 to about 2.0 miles from the wellhead of the second wellbore at the surface. In certain embodiments, a wellhead of the first wellbore at the surface may be located greater than about 10.0 miles from a wellhead of the second wellbore at the surface. In certain embodiments, the second wellbore or a portion thereof may be located within close proximity to the first wellbore or a portion thereof such that there is a risk, likelihood, potential, or the like that one or more fractures created when fracturing the second wellbore may connect with and/or come in fluid communication with the first wellbore and/or one or more fractures extending from the first wellbore. In certain embodiments, one or more fractures extending from the first wellbore may be in fluid communication with one or more fractures extending from a second wellbore. One skilled in the art with the benefit of this disclosure will recognize that portions of the first wellbore and the second wellbores located within the subterranean formation may be closer to each other than the respective wellheads at the surface.

In one or more embodiments, the introduction of the first treatment fluid may at least partially prevent the second treatment fluid and/or the particulates therein from entering the first wellbore and/or one or more fractures extending therefrom. In certain embodiments, the methods of the present disclosure may include preventing at least a portion of the second treatment fluid and/or at least a portion of the particulates therein from entering the first wellbore and/or one or more fractures extending therefrom. In certain embodiments, the weakly emulsifying surfactant in the first treatment fluid may cause the formation of an oil-in-water or water-in-oil emulsion (e.g., weak or short-lived emulsions) that may at least partially prevent the second treatment fluid and/or the particulates therein from entering the first wellbore and/or one or more fractures extending therefrom. In certain embodiments, the introduction of the first treatment fluid may at least partially pressure up the first wellbore and/or one or more fractures extending therefrom thereby at least partially prevent the second treatment fluid and/or the particulates therein from entering the first wellbore and/or one or more fractures extending therefrom.

In one or more embodiments, the methods of the present disclosure may include allowing one or more hydrocarbons to be produced from the first wellbore after introducing the second treatment fluid into the second wellbore. In certain embodiments, the first wellbore may be returned to production after the second wellbore has been fractured. In certain embodiments, hydrocarbons may be produced from the first wellbore nearly instantaneously after being returned to production and without needing to clean out or otherwise removing particulates from the first wellbore. In certain embodiments, hydrocarbons may be produced from the first wellbore for at least a period of time without the need for artificial lift and/or other stimulation treatments. Although the first wellbore may be, in certain embodiments, a production wellbore, one skilled in the art with the benefit of this disclosure will recognize that the first wellbore may also be any other type of wellbore (e.g., injection wellbore, observational wellbore, monitoring wellbore, etc.).

In certain embodiments, the weakly emulsifying surfactant may alter the wettability of the portion of the subterranean formation through ion-pair coupling between the weakly emulsifying surfactant and hydrocarbons within the subterranean formation and/or weakly emulsifying surfactant adsorption (e.g., coating) onto the surface of the weakly emulsifying surfactant. In certain embodiments, the weakly emulsifying surfactant may create a weak or short-lasting emulsion that reduces the oil-water interfacial tension thereby reducing capillary forces and increasing imbibition of the aqueous phase in the capillary pores of the subterranean formation, which may in turn allow for the treatment fluid comprising the weakly emulsifying surfactant to penetrate further into the subterranean formation and desorb hydrocarbons from the surface of the subterranean formation. As a result, hydrocarbons may be produced from the first wellbore for at least a period of time without the need for artificial lift and/or other stimulation treatments.

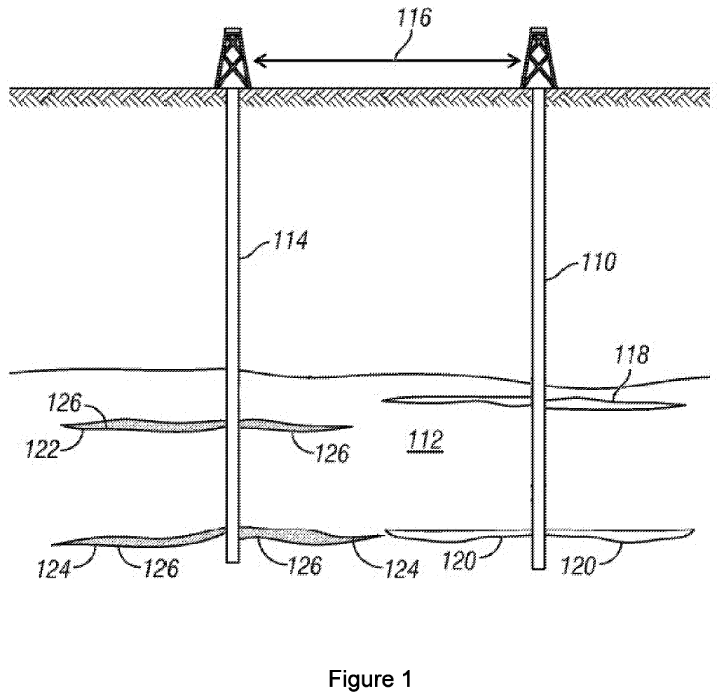

Turning now to the drawings, FIG. 1 illustrates a subterranean environment in which the methods of the present disclosure may be used. As shown in FIG. 1, a first wellbore 110 for producing hydrocarbons is shown extending through a portion of a subterranean formation 112. In accordance with certain embodiments of the present disclosure, one or more fractures 118, 120 may extend from the first wellbore 110 into the subterranean formation 112. A first treatment fluid including a base fluid and a weakly emulsifying surfactant may be introduced into the first wellbore 110 and allowed to enter fractures 118, 120. Although not pictured, the first wellbore 110 may be shut in (e.g., placed in a static state) after the first treatment fluid is introduced.

A second wellbore 114 for producing hydrocarbons is also shown extending through a portion of the subterranean formation 112. The first wellbore 110 and the second wellbore 114 are located proximate one another and separated by a distance 116 at the surface. In certain embodiments, distance 116 may be from about 0.001 mile to about 10.0 miles. Although the first wellbore 110 and the second wellbore 114 may have any orientation or inclination, for purposes of the discussion, the first wellbore 110 and the second wellbore 114 are illustrated as extending substantially vertically from the surface. Additionally, although the second wellbore 114 is shown in FIG. 1 as extending vertically from a different surface location than the first wellbore 110, the second wellbore 114 may instead extend vertically from the same surface location as the first wellbore 110 and then separate from the first wellbore 110 in another orientation (e.g., horizontally) within the subterranean formation 112. Furthermore, although the first wellbore 110 and the second wellbore 114 are shown in FIG. 1 as being substantially vertical and parallel to one another within the subterranean formation 112, the first wellbore 110 and the second wellbore 114 may have any orientation or inclination such that at least a portion of the first wellbore 110 may be located closer to than distance 116 at least a portion of the second wellbore 114. Moreover, although not picture, in certain embodiments, additional wellbores may be located proximate to the first wellbore 110 and the second wellbore 114, and the methods of the present disclosure may be employed with the additional wellbores.

In accordance with certain embodiments of the present disclosure, a second treatment fluid including a base fluid and a plurality of particulates 126 may be introduced into the second wellbore 114 at a pressure sufficient to create or enhance one or more fractures 122, 124 extending from the second wellbore 114 into the subterranean formation 112. In certain embodiments, one or more fractures 122, 124 extending from the second wellbore 114 may be located proximate to one or more fractures 118, 120 extending from the first wellbore 110 such that the fractures 122, 124 extending from the second wellbore 114 are in fluid communication with the fractures 118, 120 extending from the first wellbore 110. The plurality of particulates 126 from the second treatment fluid may be allowed to enter the fractures 122, 124 extending from the second wellbore 114. However, despite the fractures 122, 124 extending from the second wellbore 114 being in fluid communication with the fractures 118, 120 extending from the first wellbore 110, the introduction of the first treatment fluid in the first wellbore 110 may at least partially prevent the second treatment fluid and/or the particulates 126 therein from entering the fractures 118, 120 extending from the first wellbore 110. In accordance with certain embodiments of the present disclosure, the first wellbore 110 may be returned to production after the second wellbore 114 has been fractured. In certain embodiments, hydrocarbons may be produced from the first wellbore 110 without the need to clean out or otherwise remove particulates 126 from the first wellbore 110.

An embodiment of the present disclosure is a method including: introducing a first treatment fluid comprising a base fluid and a weakly emulsifying surfactant into a first wellbore penetrating at least a first portion of a subterranean formation; and introducing a second treatment fluid into a second wellbore penetrating at least a second portion of the subterranean formation at a pressure sufficient to create or enhance one or more fractures extending from the second wellbore into the subterranean formation.

In one or more embodiments described in the preceding paragraph, the first treatment fluid comprises the weakly emulsifying surfactant in an amount up to about 2.0% volume by volume of the first treatment fluid. In one or more embodiments described in the preceding paragraph, the weakly emulsifying surfactant is selected from a group consisting of: an ethoxylated amine, an ethoxylated long-chain alcohol, a polyglucoside, an alkyl ammonium bromide, an alkyl sulfonate, an alkoxylated sulfate, a hydroxysultaine, and any combination thereof. In one or more embodiments described in the preceding paragraph, the first treatment fluid further comprises an additive selected from the group consisting of: a clay stabilizer, a scale inhibitor, a biocide, an oxygen scavenger, a corrosion inhibitor, and any combination thereof. In one or more embodiments described in the preceding paragraph, the second treatment fluid comprises a plurality of particulates, and wherein the particulates are at least partially prevented from entering one or more fractures extending from the first wellbore. In one or more embodiments described in the preceding paragraph, at least a portion of the second wellbore is located from about 0.001 to about 10 miles from at least a portion of the first wellbore. In one or more embodiments described in the preceding paragraph, the one or more fractures extending from the second wellbore are in fluid communication with one or more fractures extending from the first wellbore. In one or more embodiments described in the preceding paragraph, further comprising shutting in the first wellbore at the surface after introducing the first treatment fluid and before the second treatment fluid is introduced into the second wellbore. In one or more embodiments described in the preceding paragraph, further comprising allowing one or more hydrocarbons to be produced from the first wellbore after introducing the second treatment fluid into the second wellbore. In one or more embodiments described in the preceding paragraph, the one or more hydrocarbons are produced from the first wellbore without cleaning out the first wellbore.

Another embodiment of the present disclosure is a method including: introducing a first treatment fluid comprising a first base fluid and a weakly emulsifying surfactant into a first wellbore penetrating at least a first portion of a subterranean formation, wherein one or more fractures extend from the first wellbore; and introducing a second treatment fluid comprising a second base fluid and a plurality of particulates into a second wellbore penetrating at least a second portion of the subterranean formation at a pressure sufficient to create or enhance one or more fractures extending from the second wellbore into the subterranean formation, wherein the one or more fractures extending from the second wellbore are proximate to the one or more fractures extending from the first wellbore, and wherein the particulates are at least partially prevented from entering the one or more fractures extending from the first wellbore.

In one or more embodiments described in the preceding paragraph, the first treatment fluid comprises the weakly emulsifying surfactant in an amount up to about 2.0% volume by volume of the first treatment fluid. In one or more embodiments described in the preceding paragraph, the weakly emulsifying surfactant is selected from a group consisting of: an ethoxylated amine, an ethoxylated long-chain alcohol, a polyglucoside, an alkyl ammonium bromide, an alkyl sulfonate, an alkoxylated sulfate, a hydroxysultaine, and any combination thereof. In one or more embodiments described in the preceding paragraph, further comprising shutting in the first wellbore at the surface after introducing the first treatment fluid and before the second treatment fluid is introduced into the second wellbore. In one or more embodiments described in the preceding paragraph, further comprising allowing one or more hydrocarbons to be produced from the first wellbore after introducing the second treatment fluid into the second wellbore. In one or more embodiments described in the preceding paragraph, the one or more hydrocarbons are produced from the first wellbore without cleaning out the first wellbore.

Another embodiment of the present disclosure is a method including: introducing a first treatment fluid comprising a first base fluid and a weakly emulsifying surfactant into a first wellbore penetrating at least a first portion of a subterranean formation, wherein the first treatment fluid comprises the weakly emulsifying surfactant in an amount up to about 2.0% volume by volume of the first treatment fluid; and introducing a second treatment fluid comprising a second base fluid and a plurality of particulates into a second wellbore penetrating at least a second portion of the subterranean formation, wherein at least a portion of the second wellbore is located proximate to at least a portion of the first wellbore.

In one or more embodiments described in the preceding paragraph, the weakly emulsifying surfactant is selected from a group consisting of: an ethoxylated amine, an ethoxylated long-chain alcohol, a polyglucoside, an alkyl ammonium bromide, an alkyl sulfonate, an alkoxylated sulfate, a hydroxysultaine, and any combination thereof. In one or more embodiments described in the preceding paragraph, further comprising shutting in the first wellbore at the surface after introducing the first treatment fluid and before the second treatment fluid is introduced into the second wellbore. In one or more embodiments described in the preceding paragraph, further comprising allowing one or more hydrocarbons to be produced from the first wellbore after introducing the second treatment fluid into the second wellbore.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
introducing a first treatment fluid comprising a base fluid and a weakly emulsifying surfactant into a first wellbore penetrating at least a first portion of a subterranean formation; and
introducing a second treatment fluid into a second wellbore penetrating at least a second portion of the subterranean formation at a pressure sufficient to create or enhance one or more fractures extending from the second wellbore into the subterranean formation.

2. The method of claim 1, wherein the first treatment fluid comprises the weakly emulsifying surfactant in an amount up to about 2.0% volume by volume of the first treatment fluid.

3. The method of claim 1, wherein the weakly emulsifying surfactant is selected from a group consisting of: an ethoxylated amine, an ethoxylated long-chain alcohol, a polyglucoside, an alkyl ammonium bromide, an alkyl sulfonate, an alkoxylated sulfate, a hydroxysultaine, and any combination thereof.

4. The method of claim 1, wherein the first treatment fluid further comprises an additive selected from the group consisting of: a clay stabilizer, a scale inhibitor, a biocide, an oxygen scavenger, a corrosion inhibitor, and any combination thereof.

5. The method of claim 1, wherein the second treatment fluid comprises a plurality of particulates, and wherein the particulates are at least partially prevented from entering one or more fractures extending from the first wellbore.

6. The method of claim 1, wherein at least a portion of the second wellbore is located from about 0.001 to about 10 miles from at least a portion of the first wellbore.

7. The method of claim 1, wherein the one or more fractures extending from the second wellbore are in fluid communication with one or more fractures extending from the first wellbore.

8. The method of claim 1 further comprising shutting in the first wellbore at the surface after introducing the first treatment fluid and before the second treatment fluid is introduced into the second wellbore.

9. The method of claim 1 further comprising allowing one or more hydrocarbons to be produced from the first wellbore after introducing the second treatment fluid into the second wellbore.

10. The method of claim 9, wherein the one or more hydrocarbons are produced from the first wellbore without cleaning out the first wellbore.

11. A method comprising:
introducing a first treatment fluid comprising a first base fluid and a weakly emulsifying surfactant into a first wellbore penetrating at least a first portion of a subterranean formation, wherein one or more fractures extend from the first wellbore; and
introducing a second treatment fluid comprising a second base fluid and a plurality of particulates into a second wellbore penetrating at least a second portion of the subterranean formation at a pressure sufficient to create or enhance one or more fractures extending from the second wellbore into the subterranean formation, wherein the one or more fractures extending from the second wellbore are proximate to the one or more fractures extending from the first wellbore, and wherein the particulates are at least partially prevented from entering the one or more fractures extending from the first wellbore.

12. The method of claim 11, wherein the first treatment fluid comprises the weakly emulsifying surfactant in an amount up to about 2.0% volume by volume of the first treatment fluid.

13. The method of claim 11, wherein the weakly emulsifying surfactant is selected from a group consisting of: an ethoxylated amine, an ethoxylated long-chain alcohol, a polyglucoside, an alkyl ammonium bromide, an alkyl sulfonate, an alkoxylated sulfate, a hydroxysultaine, and any combination thereof.

14. The method of claim 11 further comprising shutting in the first wellbore at the surface after introducing the first treatment fluid and before the second treatment fluid is introduced into the second wellbore.

15. The method of claim 11 further comprising allowing one or more hydrocarbons to be produced from the first wellbore after introducing the second treatment fluid into the second wellbore.

16. The method of claim 15, wherein the one or more hydrocarbons are produced from the first wellbore without cleaning out the first wellbore.

17. A method comprising:
introducing a first treatment fluid comprising a first base fluid and a weakly emulsifying surfactant into a first wellbore penetrating at least a first portion of a subterranean formation, wherein the first treatment fluid comprises the weakly emulsifying surfactant in an amount up to about 2.0% volume by volume of the first treatment fluid; and
introducing a second treatment fluid comprising a second base fluid and a plurality of particulates into a second wellbore penetrating at least a second portion of the subterranean formation, wherein at least a portion of the second wellbore is located proximate to at least a portion of the first wellbore.

18. The method of claim 17, wherein the weakly emulsifying surfactant is selected from a group consisting of: an ethoxylated amine, an ethoxylated long-chain alcohol, a polyglucoside, an alkyl ammonium bromide, an alkyl sulfonate, an alkoxylated sulfate, a hydroxysultaine, and any combination thereof.

19. The method of claim 17 further comprising shutting in the first wellbore at the surface after introducing the first treatment fluid and before the second treatment fluid is introduced into the second wellbore.

20. The method of claim 17 further comprising allowing one or more hydrocarbons to be produced from the first wellbore after introducing the second treatment fluid into the second wellbore.
